(19) United States
(12) Patent Application Publication
(10) Pub. No.: US 2025/0015868 A1
(43) Pub. Date: Jan. 9, 2025

(54) BEAM FAILURE DETECTION METHOD AND APPARATUS, TERMINAL, AND STORAGE MEDIUM

(71) Applicant: VIVO MOBILE COMMUNICATION CO., LTD., Guangdong (CN)

(72) Inventors: Yu YANG, Guangdong (CN); Chenxi WANG, Guangdong (CN)

(73) Assignee: VIVO MOBILE COMMUNICATION CO., LTD., Guangdong (CN)

(21) Appl. No.: 18/892,840

(22) Filed: Sep. 23, 2024

Related U.S. Application Data
(63) Continuation of application No. PCT/CN2023/083047, filed on Mar. 22, 2023.

(30) Foreign Application Priority Data
Mar. 23, 2022 (CN) 202210295734.1

(51) Int. Cl. H04B 7/06; H04W 72/21

(52) U.S. Cl. CPC H04B 7/06964; H04B 7/06968; H04W 72/21

(57) ABSTRACT

A beam failure detection method and apparatus, a terminal, and a storage medium, pertaining to the field of communications technologies. The beam failure detection method of the embodiments of this application includes: performing, by a terminal, measurement based on a plurality of BFD RS sets, where the plurality of BFD RS sets respectively correspond to a plurality of pieces of target information, and at least one of control channels corresponding to the target information uses a unified transmission configuration indicator TCI state; and sending a BFRQ in a case that a measurement result of at least one BFD RS set meets a preset condition.

### CROSS-REFERENCE TO RELATED APPLICATIONS

This application is a continuation of International Application No. PCT/CN2023/083047 filed on Mar. 22, 2023, which claims priority to Chinese Patent Application No. 202210295734.1 filed on Mar. 23, 2022, which are incorporated herein by reference in their entireties.

### TECHNICAL FIELD

This application pertains to the field of communication technologies, and specifically, relates to a beam failure detection method and apparatus, a terminal, and a storage medium.

### BACKGROUND

A new transmission configuration indicator (TCI) framework has been introduced in some communication systems (for example, the 5th generation (5G) or 6G system), and the TCI framework may be referred to as a unified TCI framework. In the unified TCI framework, the network indicates that a same beam can be used for multi-channel transmission. At present, the unified TCI framework introduced can support beam failure recovery (BFR) only in a scenario of one beam failure detection reference signal (BFD RS) set (or referred to as a scenario of single transmission and reception point), which leads to relatively poor transmission reliability of terminals.

### SUMMARY

According to a first aspect, a beam failure detection method is provided, including: performing, by a terminal, measurement based on a plurality of beam failure detection reference signal (BFD RS) sets, where the plurality of BFD RS sets respectively correspond to a plurality of pieces of target information, and at least one of control channels corresponding to the target information uses a unified transmission configuration indicator TCI state; and sending a beam failure recovery request (BFRQ) in a case that a measurement result of at least one BFD RS set meets a preset condition.

According to a second aspect, a beam failure detection apparatus is provided, including:
a measurement module, configured to perform measurement based on a plurality of beam failure detection reference signal BFD RS sets, where the plurality of BFD RS sets respectively correspond to a plurality of pieces of target information, and at least one of control channels corresponding to the target information uses a unified transmission configuration indicator TCI state; and
a sending module, configured to send a beam failure recovery request BFRQ in a case that a measurement result of at least one BFD RS set meets a preset condition.

According to a third aspect, a terminal is provided, where the terminal includes a processor and a memory, and a program or instructions capable of running on the processor are stored in the memory. When the program or the instructions are executed by the processor, the steps of the method according to the first aspect are implemented.

According to a fourth aspect, a terminal is provided, including a processor and a communication interface, where at least one of the processor and the communication interface is configured to perform measurement based on a plurality of beam failure detection reference signal BFD RS sets, where the plurality of BFD RS sets respectively correspond to a plurality of pieces of target information, and at least one of control channels corresponding to the target information uses a unified transmission configuration indicator TCI state; and a sending module, configured to send a beam failure recovery request BFRQ in a case that a measurement result of at least one BFD RS set meets a preset condition.

According to a fifth aspect, a beam failure detection system is provided, including a terminal and network-side device, where the terminal may be configured to execute the steps of the beam failure detection method according to the first aspect.

According to a sixth aspect, a readable storage medium is provided, where a program or instructions are stored in the readable storage medium, and when the program or the instructions are executed by a processor, the steps of the method according to the first aspect are implemented.

According to a seventh aspect, a chip is provided, where the chip includes a processor and a communications interface, the communications interface is coupled to the processor, and the processor is configured to run a program or instructions to implement the method according to the first aspect.

According to an eighth aspect, a computer program/program product is provided, where the computer program/program product is stored in a storage medium, and the computer program/program product is executed by at least one processor to implement the steps of the beam failure detection method according to the first aspect.

### BRIEF DESCRIPTION OF DRAWINGS

FIG. 1 is a block diagram of a wireless communication system to which the embodiments of this application are applicable;

FIG. 2 is a flowchart of a beam failure detection method according to an embodiment of this application;

FIG. 3 is a structural diagram of a beam failure detection apparatus according to an embodiment of this application;

FIG. 4 is a structural diagram of a communication device according to an embodiment of this application; and

FIG. 5 is a structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate a specific order or sequence. It should be understood that the data used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the associated objects are in an “or” relationship.

It should be noted that techniques described in the embodiments of this application are not limited to a long term evolution (LTE) or LTE-advanced (LTE-A) system, and may also be applied to various wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a new radio (NR) system is described for an illustration purpose, and NR terms are used in most of the following descriptions, although these technologies may also be applied to other applications than an NR system application, for example, the 6th generation (6G) communication system.

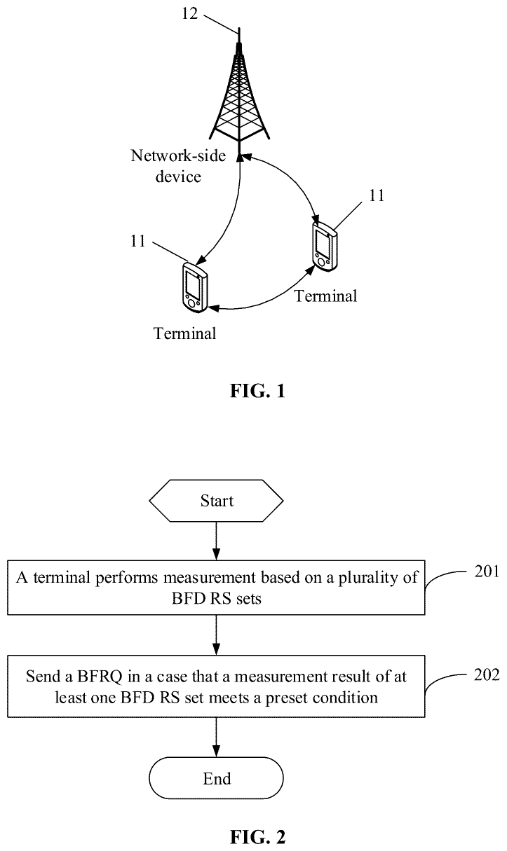

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, game console, and the like. It should be noted that a specific type of the terminal 11 is not limited in the embodiments of this application. The network-side device 12 may include an access network device or a core network device, where the access network device may also be referred to as a radio access network device, a radio access network (RAN), a radio access network function, or a radio access network unit. The access network device may include a base station, a wireless local area network (WLAN) access point, a wireless fidelity Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited. The core network device may include but is not limited to at least one of the following: a core network node, a core network function, a mobility management entity (MME), an access mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (or L-NEF), a binding support function (BSF), an application function (AF), and the like. It should be noted that, in the embodiments of this application, a core network device in an NR system is used as an example for description, and a specific type of the core network device is not limited.

With reference to the accompanying drawings, the following describes in detail, by using some embodiments and application scenarios thereof, a beam failure detection method and apparatus, a terminal, and a storage medium provided in the embodiments of this application.

In the embodiments of this application, the multi-TRP transmission technology in terms of control signaling may be divided into two cases: single downlink control information (DCI) scheduling and multi-DCI scheduling.

Multi-DCI (mDCI) scheduling: each TRP sends its own physical downlink control channel (PDCCH), each PDCCH schedules its own physical downlink shared channel (PDSCH). In this case, multiple Control resource set (CORESET) configured for the terminal are associated with different radio resource control (RRC) parameters, such as CORESET pool index, which corresponds to different TRPs. PDSCHs scheduled by two TRPs may completely overlap, partially overlap, or do not overlap, and respective physical uplink shared channel (PUSCH) scheduled by two TRPs cannot overlap.

Single-DCI (sDCI) scheduling: One TRP sends a PDCCH to schedule one PDSCH. In this case, multiple CORESETs configured for user equipment (UE) cannot be associated with different CORESETPoolIndexes. In this case, a media access control control element (MAC CE) activates a maximum of eight codepoints, and at least one codepoint corresponds to two TCI states. When a codepoint indicated by a TCI field in one DCI corresponds to two TCI states and indicates that one TCI state contains “quasi co-location typeD (QCL-TypeD)”, it means that scheduled PDSCHs are from two TRPs. The specific transmission scheme may be determined in other manners, such as: higher-layer parameter configuration or the number of demodulation reference signal (DMRS) code division multiplexing (CDM) groups indicated by DCI. The PDSCH may include a plurality of transmission schemes: data of different layers of PDSCH (scheme 1a, space division multiplexing (SDM)) correspond to two TCI states; or data on different frequency domain subcarriers correspond to two TCI states (scheme 2a/2b, frequency division multiplexing (FDM)); or each time domain repetition comes from a different TRP (scheme 3/4, time division multiplexing (TDM)).

In the embodiments of this application, a same beam indicated by MAC CE and/or DCI may be used by the network in the unified TCI framework for multiple channel transmission, and this beam can also be called a common beam.

The unified TCI framework may include two modes, namely, joint TCI and separate TCI, which can also be understood as being in two states of joint TCI and separate TCI. The two modes or states may be configured by RRC signaling of the network.

For example, the network configures a TCI state pool by using RRC signaling; a same pool is shared by joint TCI and separate downlink TCI (separate downlink (DL) TCI); separate uplink TCI (separate uplink (UL) TCI) uses an independently configured pool, and one or more TCI states are activated by using a MAC CE command. When the MAC CE activates only a TCI state corresponding to one codepoint, the activated TCI state is directly applied to a target signal. When the MAC CE activates TCI states corresponding to multiple codepoints, the network uses a TCI field in DCI to indicate one codepoint, and the TCI state corresponding to this codepoint is applied to the target signal.

For joint TCI, each codepoint corresponds to one TCI state.

For separate TCI, each codepoint may correspond to one DL TCI state and one UL TCI state, or one DL TCI state, or one UL TCI state.

When the network uses DCI for beam indication, it supports DCI formats 1_1/1_2 with downlink assignment (DCI formats 1_1/1_2 with DL assignment) and DCI formats 1_1/1_2 without downlink assignment (DCI format 1_1/1_2 without DL assignment).

Beam application time of a TCI state indicated by beam indication DCI is defined as that the first slot to apply the indicated TCI is at least Y symbols after the last symbol of the acknowledgment of the joint or separate DL/UL beam indication (the first slot to apply the indicated TCI is at least Y symbols after the last symbol of the acknowledgment of the joint or separate DL/UL beam indication).

Path loss reference signal (PLRS) in power control parameters may be configured by the network to be in or associated with TCI state.

Other parameters in power control parameters (open-loop receiver power target value PO, partial path loss compensation factor alpha, and closed-loop power control index (CLI)) may be configured by the network to be associated with TCI state. Physical uplink control channel (PUCCH), physical uplink shared channel (PUSCH), and sounding reference signal (SRS) may all have their own settings associated with TCI state or included in configuration information of each channel.

For a carrier aggregation (CA) scenario, the network can indicate a common TCI state ID, which is used for determining QCL information of downlink target signals and/or transmission space filter information of uplink target signals in a group of CC.

The source reference signal (source RS) of TCI state may include the following:
DL: channel state information-reference signal for beam management ((Channel state information-Reference Signal, CSI-RS) for beam management), and channel state information reference signal for tracking (CSI-RS for tracking).
UL: synchronization signal block (SSB), channel state information reference signal (CSI-RS for beam management), channel state information reference signal for tracking (CSI-RS for tracking), and sounding reference signal for beam management (SRS for beam management).

A target signal of TCI state may be as follows:
DL: terminal-dedicated reception on PDSCH (UE-dedicated reception on PDSCH), terminal-dedicated reception on all or subset of CORESETs (UE-dedicated reception on all or subsets of CORESETs), aperiodic CSI-RS resources for CSI, aperiodic CSI-RS resources for BM, and DMRS(s) associated with CORESETs and their associated PDSCHs that are not for terminal-dedicated reception (these CORESETs and their associated PDSCHs are associated serving cells PCI).
UL: dynamic-grant/configured-grant based PUSCH (, all of dedicated PUCCH resources (all of dedicated PUCCH resources), aperiodic SRS resources or resource sets for beam management, SRS for antenna switching, SRS for codebook, and SRS for non-codebook.

In addition, in the embodiments of this application, the unified TCI state can also be referred to as R17 TCI state, and configuring the unified TCI state can also be understood as configuring a TCI state pool or TCI mode (joint TCI or separate TCI) with unified TCI and other information.

It should be noted that the beam information described in the embodiments of this application may also be referred to as: identification information of beam, spatial relation information, spatial domain transmission filter information, spatial domain reception filter information, spatial filter information, transmission configuration indicator state (TCI state) information, quasi co-location (QCL) information, QCL parameter, or the like. Downlink beam information may usually be represented by using TCI state information or QCL information. Uplink beam information may be usually represented by using TCI state information or spatial relation information.

Referring to FIG. 2, FIG. 2 is a flowchart of a beam failure detection method according to an embodiment of this application. As shown in FIG. 2, the method includes the following steps.

Step 201: A terminal performs measurement based on a plurality of BFD RS sets, where the plurality of BFD RS sets respectively correspond to a plurality of pieces of target information, and at least one of control channels corresponding to the target information uses a unified TCI state.

The plurality of BFD RS sets may be explicitly or implicitly configured by a network-side device, and the plurality of BFD RS sets being respectively corresponding to a plurality of pieces of target information may be that the plurality of BFD RS sets respectively correspond to a plurality of TCI states indicated by the network, that is, each BFD RS set uses one TCI state indicated by the network, or that the plurality of BFD RS sets respectively correspond to a plurality of TRPs, that is, each piece of target information represents one TRP and corresponds to one BFD RS set.

At least one of control channels corresponding to the target information uses a unified transmission configuration indicator TCI state, which may be that control channels corresponding to any one piece of target information may at least include a control channel using the unified TCI state.

The control channel using the unified TCI state may be that the target information corresponding to the control channel is configured or indicated by the unified TCI state, and the control channel belongs to the target signal of the unified TCI state, that is, the control channel needs to apply the unified TCI state, so at least one control channel on each piece of target information needs to use a unified TCI state configured or indicated by the network for the target information.

In addition, the network device configures a unified TCI state for the terminal, and the configuration may be applied to all component carriers (CC) in one band, or may be applied to one CC or one cell, or may be applied to one bandwidth part (BWP).

The measurement based on a plurality of BFD RS sets may be to determine whether there is a measurement result satisfying a preset condition, or to determine at least one BFD RS set whose measurement result satisfies a preset condition.

In the embodiments of this application, each BFD RS set includes at least one BFD-RS, and the number of BFD-RSs in each BFD RS set and the total number of BFD-RSs in all BFD RS sets meet a quantity supported by a terminal capability.

Step 202: Send a BFRQ in a case that a measurement result of at least one BFD RS set meets a preset condition.

The preset condition to be met may be a condition for determining occurrence of a beam failure, and the preset condition may be a preset condition defined by a protocol or a preset condition configured by the network-side device. This condition is not limited by the embodiments of this application.

For example, the physical layer of the terminal performs measurement on radio link quality based on a BFD RS, and determines whether a beam failure event occurs based on a measurement result. The judgment condition is: if measurement results of all BFD RS resources are lower than the preset threshold, it is determined as a beam failure instance (BFI), and the physical layer of the terminal reports an indication to a higher layer (MAC layer) of the terminal, and a reporting period is a maximum value of the shortest period of BFD RS and 2 ms. The higher layer of the terminal uses a counter and a timer to count BFIs reported by the physical layer, restarts the timer each time a BFI is received, and restarts the counter when the timer expires. When the counter reaches a maximum quantity of times configured by the network, the terminal determines that a beam failure event occurs.

In this embodiment of this application, through the steps, BFR initiation based on a unified TCI framework in a scenario with a plurality of BFD RS sets (or may be called a multiple-transmission and reception point scenario) is supported, thus improving transmission reliability of the terminal. For example, BFR initiation based on the unified TCI framework in a multi-TRP scenario is supported, so as to improve transmission reliability of the terminal. For example, in a case of applying the unified TCI framework in the multi-TRP scenario, through the foregoing steps, the network and the terminal can quickly recover an interrupted beam link in this scenario, thus improving reliability of data transmission and improving user experience.

In this embodiment of this application, after the BFRQ is sent, the method further includes: the terminal receives a beam failure recovery response (BFRR).

In an optional implementation, the target information includes at least one of the following:
a CORESET pool index (CORESETPoolIndex), a TRP identifier, a channel group identifier, a CORESET group identifier, a PUCCH resource group identifier, a unified TCI state indicated by a network, a codepoint corresponding to the unified TCI state indicated by the network, and a physical cell identifier (PCI).

In this implementation, the target information can implement BFR for at least one of the foregoing items.

In an optionally implementation, in a case that the plurality of BFD RS sets are explicitly configured on a network side, the method further includes:
updating, by the terminal, a TCI state of each BFD RS in the plurality of BFD RS sets based on at least one of the following:
RRC signaling;
MAC CE; and
a unified TCI state indicated by a network, where the unified TCI state indicated by the network corresponds to same target information as a BFD RS set to which the BFD RS belongs, or the unified TCI state indicated by the network has a correspondence with the BFD RS set to which the BFD RS belongs.

The unified TCI state indicated by the network may be a unified TCI state for at least one of PDCCH, PDSCH, and CSI-RS.

In this implementation, it is possible to reconfigure a TCI state of at least one BFD-RS based on RRC signaling, to update a TCI state of at least one BFD-RS through MAC CE, and to update a TCI state of at least one BFD-RS through the unified TCI state indicated by the network; or to update a TCI state of at least one BFD-RS through a correspondence between the unified TCI state indicated by the network and a BFD RS set to which the BFD RS belongs, thereby achieving the effect of flexibly updating the TCI state of the BFD-RS.

In an optionally implementation, in a case that the plurality of BFD RS sets are explicitly configured on a network side:
a BFD RS resource of the i-th BFD RS set in the plurality of BFD RS sets is the same as or quasi-co-located QCLed with a source RS of a unified TCI state corresponding to the i-th target information corresponding to the i-th BFD RS set; or
the BFD RS resource of the i-th BFD RS set in the plurality of BFD RS sets is QCLed with a PDCCH on a target CORESET of the i-th target information; where
i is a positive number greater than or equal to 1 and less than N, and N is the number of BFD RS sets of the plurality of BFD RS sets.

The unified TCI state corresponding to the i-th target information may be that at least one of control channels corresponding to the i-th target information uses the unified TCI state.

The foregoing target CORESET may be part or all of CORESETs of the i-th target information, such as a CORESET associated with common search space (CSS), a CORESET associated with CSS and terminal-specific search space (UE-specific search space, USS), a CORESET associated with USS, or all CORESETs, or a CORESET using the unified TCI state of the i-th target information.

In an optionally implementation, in a case that the plurality of BFD RS sets are implicitly configured on a network side:
a source RS of a first TCI state is used as a BFD RS of a first BFD RS set in the plurality of BFD RS sets, where the first TCI state includes a unified TCI state used by a CORESET associated with target information corresponding to the first BFD RS set; or
a source RS of a second TCI state is used as a BFD RS of a second BFD RS set in the plurality of BFD RS sets, where the second TCI state includes a TCI state corresponding to the same target information as the second BFD RS set; or
a source RS of a third TCI state is used as a BFD RS of a third BFD RS set in the plurality of BFD RS sets, where the third TCI state includes a TCI state corresponding to third BFD RS set; or
a source RS of a fourth TCI state is used as a BFD RS in the plurality of BFD RS sets, where the fourth TCI state includes: a TCI state of a CORESET associated with the terminal or a TCI state of a CORESET associated with the terminal and using a unified TCI state indicated by a network.

The first BFD RS set, the second BFD RS set, and the third BFD RS set may be any one BFD RS set in the plurality of BFD RS sets, for example, the first BFD RS set, the second BFD RS set, and the third BFD RS set may all be expressed as the k-th BFD RS set. The TCI state of same target information corresponding to the second BFD RS set may be a TCI state corresponding to CORESETPoolIndex k, or a TCI state corresponding to channel group K, or a TCI state corresponding to CORESET group k, or a TCI state corresponding to PUCCH resource group k, or a TCI state corresponding to a network-indicated TCI state (indicated TCI state) k.

The TCI state of the CORESET associated with the terminal may be TCI states of all CORESETs associated with the terminal.

In an implementation, in a case of mDCI scheduling, a source RS of a first TCI state may be used as a BFD RS of the first BFD RS set in the plurality of BFD RS sets, or a source RS of the second TCI state may be used as a BFD RS of the second BFD RS set in the plurality of BFD RS sets, or a source RS of the third TCI state may be used as a BFD RS of the third BFD RS set in the plurality of BFD RS sets.

Alternatively, in a case of sDCI scheduling, the source RS of the second TCI state may be used as the BFD RS of the second BFD RS set in the plurality of BFD RS sets, or the source RS of the third TCI state may be used as the BFD RS of the third BFD RS set in the plurality of BFD RS sets, or the source RS of the fourth TCI state may be used as the BFD RS in the plurality of BFD RS sets.

In this implementation, in a case of implicit configuration, a source RS of each unified TCI state indicated by the network may be used as a BFD RS in each BFD RS set, for example, the network indicates two unified TCI states, in which a source RS of the 1st unified TCI state is used as a BFD RS in the 1st BFD RS set, and a source RS of the 2nd unified TCI state is used as a BFD RS in the 2nd BFD RS set, so as to implement flexible configuration of a BFD RS in the BFD RS set.

In an optional embodiment, a plurality of new beam identification reference signal (NBI-RS) sets are configured for the terminal, and the plurality of NBI-RS sets are in one-to-one correspondence to the plurality of BFD RS sets.

Because the plurality of NBI-RS sets are in one-to-one correspondence to the plurality of BFD RS sets, a new beam corresponding to each BFD RS set can be identified, thereby improving performance of beam failure recovery.

Optionally, a BFD RS set and a NBI-RS set having a correspondence are associated with same target information.

In this way, a new beam is identified for different target information.

Optionally, at least two NBI-RS of a first NBI-RS set in the plurality of NBI-RS sets are associated with different target information.

At least two NBI-RS of the first NBI-RS set being associated with different target information may be that each NBI-RS resource in the first NBI-RS set is associated with different target information, and the associated target information may include target information corresponding to a BFD-RS set corresponding to the NBI-RS set. Alternatively, at least two NBI-RS of the first NBI-RS set being associated with different target information may be that part of NBI-RS resources in the first NBI-RS set are associated with different target information, and part of NBI-RS resources are associated with same target information. In addition, the target information associated with the first NBI-RS set may include target information corresponding to a BFD-RS set corresponding to the NBI-RS set.

The first NBI-RS set may be any one NBI-RS set in the plurality of NBI-RS sets, that is, each NBI-RS set has at least two NBI-RSs being associated with different target information; or, the first NBI-RS set may be part of NBI-RS sets in the plurality of NBI-RS sets, that is, only part of NBI-RS sets have at least two NBI-RSs being associated with different target information, and each NBI-RS in the remaining NBI-RS sets is associated with same target information.

Because at least two NBI-RSs in the first NBI-RS set are associated with different target information, new beam identification may be implemented for more target information, further improving performance of beam failure recovery.

In an optional implementation, the sending a BFRQ includes at least one of the following:
sending a BFR MAC CE by using an available uplink grant;
sending a physical uplink control channel scheduling request (PUCCH-SR); and
performing contention-based random access (CBRA).

The BFR MAC CE may be used for all TRPs of all CCS in one cell group, and may carry at least one of the following:
an index of a failed BFD-RS set;
an index of a CC containing a failed TRP or containing a failed BFD-RS set (index of CC containing the failed TRP or containing the failed BFD-RS set);
indication information of one new beam for a failed TRP/BFD-RS set/CC (1 new beam for the failed TRP/BFD-RS set/CC);
indication information of whether a new beam is detected; and
an index of a cell in which a failure occurs.

In this implementation, flexible transmission of BFRQ can be implemented in a plurality of manners, thereby improving performance of beam failure recovery.

Optionally, in a case that a unified TCI state used by at least one of control channels corresponding to first target information is a joint TCI (joint TCI) state, and radio link measurement results, detected by the terminal, of all BFD RS resources in the BFD RS set corresponding to the first target information are lower than a first preset threshold, the sending a BFR MAC CE by using an available uplink grant includes at least one of the following:
sending the BFR MAC CE by using a latest available uplink grant (available UL grant) of the first target information;
sending the BFR MAC CE by using a latest available uplink grant of second target information in the plurality of pieces of target information, where a measurement result not lower than the first preset threshold is present in radio link measurement results, detected by the terminal, of all BFD RS resources in a BFD RS set corresponding to the second target information; and
sending the BFR MAC CE by using M latest available uplink grants of M pieces of target information in the plurality of pieces of target information, where the M pieces of target information are target information with a latest available uplink grant in the plurality of pieces of target information, and M is an integer greater than or equal to 1.

The first target information is one or more of the plurality of pieces of target information, and the second target information is one or more of the plurality of pieces of target information other than the first target information.

The unified TCI state used by at least one of the control channels corresponding to the first target information being a joint TCI state may be that: the network-side device configures the joint TCI state for the terminal (in this case, a CC or BWP corresponding to the first target information is configured with the joint TCI state that is applied to all the target information corresponding to the CC or BWP, or all the target information corresponding to the CC or BWP corresponding to the first target information are configured with the same TCI state, that is, the joint TCI state); or may configure the joint TCI state for the first target information (in this case, the TCI state configured for other target information corresponding to the CC or BWP corresponding to the first target information may be a joint TCI state or a separate TCI state).

The first preset threshold may be defined by the protocol or configured by the network side.

The radio link measurement results, detected by the terminal, of all the BFD RS resources in the BFD RS set corresponding to the first target information being lower than the first preset threshold can be understood as that a beam failure occurs to the first target information or the BFD RS set corresponding to the first target information.

The sending the BFR MAC CE by using the latest available uplink grant of the first target information may be: sending the BFR MAC CE by using the latest available uplink grant of the first target information directly; or the sending the BFR MAC CE by using the latest available uplink grant of the first target information may include:
in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received, sending the BFR MAC CE by using the latest available uplink grant of the first target information.

The sending the BFR MAC CE by using the latest available uplink grant of the second target information in the plurality of pieces of target information may be: sending the BFR MAC CE by using the latest available uplink grant of the second target information directly; or the sending the BFR MAC CE by using the latest available uplink grant of the second target information in the plurality of pieces of target information may include:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received, sending the BFR MAC CE by using the latest available uplink grant of the second target information.

The sending the BFR MAC CE by using M latest available uplink grants of the M pieces of target information in the plurality of pieces of target information may be: sending the BFR MAC CE by using latest available uplink grants of all target information. For example, if each piece of target information has the latest available uplink grant, a plurality of latest available uplink grants of the plurality of pieces of target information are used to send the BFR MAC CE. For example, if only two pieces of target information have the latest available uplink grants, two latest available uplink grants of the two pieces of target information are used to send the BFR MAC CE.

In this implementation, the BFR MAC CE may be sent by using the latest available uplink grant (available UL grant) of the first target information, the second target information, or a plurality of pieces of target information, so as to speed up BFRQ transmission, ensuring successful transmission of BFRQ and improving performance of beam failure recovery.

Optionally, in a case that a unified TCI state used by at least one of control channels corresponding to first target information is a joint TCI state, the sending a PUCCH-SR includes at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
sending the PUCCH-SR in a case that the terminal does not have a latest available uplink grant of second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received; and
sending the PUCCH-SR in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, where the M pieces of target information are target information with a latest available uplink grant in the plurality of pieces of target information, and M is an integer greater than or equal to 1.

In this implementation, in a case that the unified TCI state used by at least one of the control channels corresponding to the first target information is a joint TCI state and the radio link measurement results, detected by the terminal, of all the BFD RS resources in the BFD RS set corresponding to the first target information are lower than the first preset threshold, the terminal may directly send the PUCCH-SR to the network.

The sending the PUSCH-SR may include at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a first BFD RS set corresponding to the first target information; and
in a case that a plurality of PUCCH-SR resources are configured for the terminal, sending the PUCCH-SR by using a PUCCH-SR resource corresponding to the second target information in the plurality of pieces of target information, or sending the PUCCH-SR by using a PUCCH-SR resource corresponding to a second BFD RS set corresponding to the second target information in the plurality of pieces of target information.

Optionally, the PUCCH-SR resource is located in a primary cell Pcell; or
the PUCCH-SR resource is associated with a neighboring cell PCI (additional PCI); or
the PUCCH-SR resource is located in a cell in which no beam failure occurs.

One PUCCH-SR resource or a plurality of PUCCH-SR resources may be located in the primary cell Pcell, or one PUCCH-SR resource or a plurality of PUCCH-SR resources may be associated with a neighboring cell PCI, or one PUCCH-SR resource or a plurality of PUCCH-SR resources may be located in a cell in which a beam failure does not occur.

In the foregoing implementation, flexible PUCCH-SR transmission may be implemented in a plurality of PUCCH-SR transmission manners described above, thereby improving recovery performance of beam failure recovery.

Optionally, a TCI state of the PUCCH-SR is determined based on a joint TCI state or an uplink TCI state of the second target information in the plurality of pieces of target information, where a measurement result not lower than a first preset threshold is present in radio link measurement results, detected by the terminal, of all BFD RS resources in a second BFD RS set corresponding to the second target information; or
a TCI state of the PUCCH-SR is determined based on a TCI state of target information associated with a PUCCH-SR resource; or
a TCI state of the PUCCH-SR is determined based on a TCI state of a BFD-RS set associated with a PUCCH-SR resource; or
the terminal performs repetition transmission of the PUCCH-SR based on a TCI state of the plurality of pieces of target information; or
the terminal performs repetition transmission of the PUCCH-SR based on a TCI state of the plurality of BFD RS sets.

In a case that the TCI state of the PUCCH-SR is determined based on the joint TCI state or the uplink TCI state of the second target information in the plurality of pieces of target information, reliable PUCCH-SR transmission can be ensured because the second target information does not have a beam failure, and the network side may alternatively determine, based on the TCI state of the PUCCH-SR, that the beam failure is for the first target information, or may alternatively indicate an uplink grant corresponding to the second target information for subsequent transmission of BFR MAC CE.

The terminal performing repetition transmission of the PUCCH-SR based on the TCI states of the plurality of pieces of target information may be that: the TCI states of the plurality of pieces of target information are used as a plurality of TCI states of the PUCCH-SR, and a same PUCCH-SR is repeatedly transmitted to the network separately based on the TCI states of the plurality of pieces of target information. The terminal performing repetition transmission of the PUCCH-SR based on the TCI states of the plurality of BFD RS sets may be that: the TCI states of the plurality of BFD RS sets are used as a plurality of TCI states of the PUCCH-SR, and a same PUCCH-SR is repeatedly transmitted to the network separately based on the TCI states of the plurality of BFD RS sets.

In addition, parameter information of a transmission mode for PUCCH-SR repetition transmission is pre-configured by the network or defined by the protocol.

In this implementation, flexible PUCCH-SR transmission in a plurality of TCI states can be implemented, so as to improve a transmission success rate of the PUCCH-SR.

Optionally, in a case that a unified TCI state used by at least one of control channels corresponding to first target information is a joint TCI state, the performing CBRA includes at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received;
performing CBRA in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, where the M pieces of target information are target information with a latest available uplink grant in the plurality of pieces of target information, and M is an integer greater than or equal to 1;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in lower than a first preset threshold; and
performing CBRA in a case that radio link measurement results, detected by the terminal, of all BFD RS resources in the plurality of BFD RS sets are lower than the first preset threshold.

In this implementation, the CBRA may be performed in a case that the unified TCI state used by at least one of the control channels corresponding to the first target information is a separate TCI state and the radio link measurement results, detected by the terminal, of all the BFD RS resources in the BFD RS set corresponding to the first target information are lower than the first preset threshold.

In this implementation, CBRA may be flexibly performed in the foregoing plurality of manners to speed up beam failure recovery.

Optionally, in a case that a unified TCI state used by at least one of control channels corresponding to first target information is a joint TCI state, the performing CBRA includes at least one of the following:
performing, by the terminal, repetition transmission of a random access channel (RACH) based on a TCI state of the plurality of pieces of target information; or
performing, by the terminal, repetition transmission of a RACH based on a TCI state of the plurality of BFD RS sets.

The terminal performing repetition transmission of the RACH based on the TCI states of the plurality of pieces of target information may be that: the TCI states of the plurality of pieces of target information are used as a plurality of TCI states of the RACH, and a same RACH is repeatedly transmitted to the network separately based on the TCI states of the plurality of pieces of target information. The terminal performing repetition transmission of the RACH based on the TCI states of the plurality of BFD RS sets may be that: the TCI states of the plurality of BFD RS sets are used as a plurality of TCI states of the RACH, and a same RACH is repeatedly transmitted to the network separately based on the TCI states of the plurality of BFD RS sets.

In this implementation, a success rate of CBRA can be improved.

Optionally, in a case that a unified TCI state used by at least one of control channels corresponding to first target information is a separate TCI state, and radio link measurement results, detected by the terminal, of all BFD RS resources in the BFD RS set corresponding to the first target information are lower than a first preset threshold, the sending a BFR MAC CE by using an available uplink grant includes at least one of the following:
sending the BFR MAC CE by using a latest available uplink grant of the first target information; and
sending the BFR MAC CE by using a latest available uplink grant of third target information in the plurality of pieces of target information.

The first target information is one or more of the plurality of pieces of target information, the third target information is one or more of the plurality of pieces of target information other than the first target information, or the third target information is one or more of the plurality of pieces of target information.

The sending the BFR MAC CE by using the latest available uplink grant of the third target information in the plurality of pieces of target information may be: sending the BFR MAC CE by using the latest available uplink grant of the third target information directly; or the sending the BFR MAC CE by using the latest available uplink grant of the third target information in the plurality of pieces of target information may include:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information and beam failure recovery response information of the network side is not received, sending the BFR MAC CE by using the latest available uplink grant of the third target information.

The unified TCI state used by at least one of the control channels corresponding to the first target information being a separate TCI state may be that: the network-side device configures the separate TCI state for the terminal (in this case, a CC or BWP corresponding to the first target information is configured with the separate TCI state that is applied to all the target information corresponding to the CC or BWP, or all the target information corresponding to the CC or BWP corresponding to the first target information are configured with the same TCI state, that is, the separate TCI state); or may configure the separate TCI state for the first target information (in this case, the TCI state configured for other target information corresponding to the CC or BWP corresponding to the first target information may be a separate TCI state or a separate TCI state). In this implementation, the BFR MAC CE can be sent by using the latest available uplink grant of the first target information, or the BFR MAC CE can be sent by using the latest available uplink grant of the third target information, or the BFR MAC CE can be sent by using the latest available uplink grants of the first target information and the third target information, so as to speed up BFRQ transmission, thereby ensuring successful BFRQ transmission and improving performance of beam failure recovery.

Optionally, in a case that a unified TCI state used by at least one of control channels corresponding to first target information is a separate TCI state, the sending a PUCCH-SR includes at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received; and
sending the PUCCH-SR in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received.

In this implementation, in a case that the unified TCI state used by at least one of the control channels corresponding to the first target information is a separate TCI state and the radio link measurement results, detected by the terminal, of all the BFD RS resources in the BFD RS set corresponding to the first target information are lower than the first preset threshold, the terminal may directly send the PUCCH-SR to the network.

The sending the PUSCH-SR may include at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a BFD RS set corresponding to the first target information; and
in a case that a plurality of PUCCH-SR resources are configured for the terminal, sending the PUCCH-SR by using a PUCCH-SR resource corresponding to the third target information in the plurality of pieces of target information, or sending the PUCCH-SR by using a PUCCH-SR resource corresponding to a BFD RS set corresponding to the third target information in the plurality of pieces of target information.

Optionally, the PUCCH-SR resource is located in a primary cell Pcell; or
the PUCCH-SR resource is associated with a neighboring cell PCI; or
the PUCCH-SR resource is located in a cell in which no beam failure occurs.

One PUCCH-SR resource or a plurality of PUCCH-SR resources may be located in the primary cell Pcell, or one PUCCH-SR resource or a plurality of PUCCH-SR resources may be associated with a neighboring cell PCI, or one PUCCH-SR resource or a plurality of PUCCH-SR resources may be located in a cell in which a beam failure does not occur.

In the foregoing implementation, flexible PUCCH-SR transmission may be implemented in a plurality of PUCCH-SR transmission manners described above, thereby improving performance of beam failure recovery.

Optionally, a TCI state of the PUCCH-SR is determined based on an uplink TCI state of the first target information; or
a TCI state of the PUCCH-SR is determined based on a joint TCI state or an uplink TCI state of the third target information in the plurality of pieces of target information; or
a TCI state of the PUCCH-SR is determined based on a TCI state of target information associated with a PUCCH-SR resource; or
a TCI state of the PUCCH-SR is determined based on a TCI state of a BFD-RS set associated with a PUCCH-SR resource; or
the terminal performs repetition transmission of the PUCCH-SR based on a TCI state of the plurality of pieces of target information; or
the terminal performs repetition transmission of the PUCCH-SR based on a TCI state of the plurality of BFD RS sets.

In this implementation, flexible PUCCH-SR transmission in a plurality of TCI states can be implemented, so as to improve a transmission success rate of the PUCCH-SR.

Optionally, in a case that a unified TCI state used by at least one of control channels corresponding to first target information is a separate TCI state, the performing CBRA includes at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in a BFD RS set corresponding to a PUCCH-SR resource used for sending the PUCCH-SR are lower than a first preset threshold; and
performing CBRA in a case that radio link measurement results, detected by the terminal, of all BFD RS resources in the plurality of BFD RS sets are lower than the first preset threshold.

In this implementation, the CBRA may be performed in a case that the unified TCI state used by at least one of the control channels corresponding to the first target information is a separate TCI state and the radio link measurement results, detected by the terminal, of all the BFD RS resources in the BFD RS set corresponding to the first target information are lower than the first preset threshold.

In this implementation, CBRA may be flexibly performed in the foregoing plurality of manners to speed up beam failure recovery.

Optionally, in a case that a unified TCI state used by at least one of control channels corresponding to first target information is a separate TCI state, the performing CBRA includes at least one of the following:
performing, by the terminal, repetition transmission of a RACH based on a TCI state of the plurality of pieces of target information; or
performing, by the terminal, repetition transmission of a RACH based on a TCI state of the plurality of BFD RS sets.

The terminal performing repetition transmission of the RACH based on the TCI states of the plurality of pieces of target information may be that: the TCI states of the plurality of pieces of target information are used as a plurality of TCI states of the RACH, and a same RACH is repeatedly transmitted to the network separately based on the TCI states of the plurality of pieces of target information. The terminal performing repetition transmission of the RACH based on the TCI states of the plurality of BFD RS sets may be that: the TCI states of the plurality of BFD RS sets are used as a plurality of TCI states of the RACH, and a same RACH is repeatedly transmitted to the network separately based on the TCI states of the plurality of BFD RS sets.

In this implementation, a success rate of CBRA can be improved.

As an optional implementation, after the BFRQ is sent, the method further includes:
in a case that radio link measurement results of all BFD RS resources in a BFD-RS set associated with a PCI of a serving cell are lower than a first preset threshold, and that no new beam is detected based on an NBI-RS set corresponding to the BFD-RS set, performing one of the following:
performing a cell handover;
performing a random access procedure; and
performing a radio link failure and reestablishment procedure.

The serving cell may be a serving cell associated with CORESET #0, and the CORESET #0 is CORESET #0 defined by the protocol or configured by the network. In this implementation, the network may configure CORESET #0 associated with the serving cell PCI.

In this implementation, at least one of the foregoing can be executed in the foregoing cases, so that reliability of data transmission of the terminal can be improved and user experience can be improved.

As an optional implementation, the method further includes:
the terminal receives a BFRR, where the BFRR includes at least one of the following:
first DCI that carries a toggled new data identifier (toggled NDI) and schedules a PUSCH by using a same hybrid automatic repeat request (HARQ) process identifier ID as a PUSCH in which a BFR MAC CE is located, where the BFR MAC CE is a BFR MAC CE sent by the terminal; and
second DCI for indicating a unified TCI state.

The first DCI may be used to indicate the unified TCI state.

In addition, the second DCI includes the first DCI, or the second DCI is different from the first DCI.

In this implementation, at least one of the first DCI and the second DCI may be used as a BFRR, or DCI with signaling content of the first DCI and the second DCI may be used as the BFRR, so that the terminal can determine completion of beam failure recovery according to the BFRR and determine to-be-switched-to beam information, implementing fast and accurate beam failure recovery. In addition, it can also avoid introducing additional signaling as a BFRR to save resource overheads.

Optionally, the unified TCI state indicated by the second DCI is a TCI state determined based on a new beam indicated in the BFR MAC CE.

Because the unified TCI state indicated by the second DCI is a TCI state determined based on the new beam indicated by the BFR MAC CE, switching to a new unified TCI state based on the new beam indicated by the BFR MAC CE can be implemented.

Optionally, a TCI state of the BFRR is determined based on a new beam indicated in the BFR MAC CE; or
a TCI state of the BFRR is determined based on a TCI state of fourth target information in the plurality of pieces of target information, where a measurement result not lower than a first preset threshold is present in radio link measurement results, detected by the terminal, of all BFD RS resources in a BFD RS set corresponding to the fourth target information.

The fourth target information may be one or more pieces of target information other than the first target information in the plurality of pieces of target information.

In this implementation, the TCI state of the BFRR can be determined based on the new beam indicated in the BFRQ, or the TCI state of the BFRR can be determined based on the TCI state of the fourth target information, so as to ensure that the BFRR can be transmitted on a beam link with good radio link quality, ensuring reliability of BFRR transmission and implementing flexible determining of the TCI state of the BFRR.

Optionally, the method further includes:
determining a TCI state of a target channel based on a target parameter starting from a preset time after reception of the BFRR.

The target channel includes at least one of the following:
a downlink channel associated with first target information;
a downlink channel associated with a first BFD RS set corresponding to the first target information;
a downlink channel using a unified TCI state indicated by a network;
an uplink channel associated with the first target information;
an uplink channel associated with the first BFD RS set; and
an uplink channel using a unified TCI state indicated by the network.

Radio link measurement results, detected by the terminal, of all BFD RS resources in a BFD RS set corresponding to the first target information are lower than a first preset threshold.

The downlink channel associated with the first target information may be part or all of downlink channels associated with the first target information, and the uplink channel associated with the first target information may be part or all of uplink channels associated with the first target information. The part of downlink channels or the part of uplink channels may be downlink channels using a unified TCI state in all downlink channels associated with the first target information, and uplink channels using a unified TCI state in all uplink channels associated with the first target information.

The downlink channels associated with the first BFD RS set corresponding to the first target information may be part or all of downlink channels associated with the first BFD RS set corresponding to the first target information, and the uplink channels associated with the first BFD RS set corresponding to the first target information may be part or all of uplink channels associated with the first BFD RS set corresponding to the first target information. The part of downlink channels or the part of uplink channels may be downlink channels using a unified TCI state in all downlink channels associated with the first BFD RS set corresponding to the first target information and uplink channels using a unified TCI state in all uplink channels associated with the first BFD RS set corresponding to the first target information.

The downlink channels using the unified TCI state indicated by the network may be part or all of downlink channels using the unified TCI state indicated by the network, and the uplink channels using the unified TCI state indicated by the network may be part or all of uplink channels using the unified TCI state indicated by the network. In addition, for example, when a cell in which the beam failure occurs is a primary cell, in a case that the target channel includes all downlink control channels associated with the first target information or the BFD-RS set corresponding to the first target information, their associated PDSCHs, and CSI-RSs configured as sharing a unified TCI state, TCI states of uplink channels associated with the first target information or the BFD-RS set corresponding to the first target information and SRSs configured as sharing a unified TCI state can be determined based on a nearest physical random access channel (PRACH).

In addition, for example, when a cell in which the beam failure occurs is a secondary cell, TCI states of all downlink control channels associated with the first target information or the BFD-RS set corresponding to the first target information, their associated PDSCHs, CSI-RSs configured as sharing a unified TCI state, uplink channels, and SRSs configured as sharing a unified TCI state can be determined based on new beam information indicated by the BFR MAC CE.

The target parameter may include at least one of the following:
new beam information indicated by the BFR MAC CE;
a TCI state indicated by the BFRR; and
beam information of a latest transmitted PRACH.

The preset time may include at least one of the following:
X symbols after reception of the BFRR, where X is a positive integer;
a beam application time of a unified TCI state indicated by the BFRR; and
a minimum value or maximum value of X symbols after reception of the BFRR and the beam application time of the unified TCI state indicated by the BFRR.

In a case that the DCI of the BFRR indicates a unified TCI state, the application time of the TCI state indicated by the DCI may be X symbols after reception of the BFRR, or the 1st slot behind X symbols after reception of the BFRR.

In a case that the DCI of the BFRR indicates a unified TCI state, a time for resetting or updating a beam of the target channel may be a beam application time of the unified TCI state indicated by the DCI.

In this implementation, because the TCI state of the target channel is determined based on the target parameter starting from the preset time after reception of the BFRR, the network side and the terminal have consistent understanding on the time for determining the TCI state of the target channel, thereby improving transmission reliability of the target channel.

Optionally, the preset time is determined based on a minimum value of a subcarrier spacing of an active BWP in which the BFRR is located and a subcarrier spacing of an active BWP in a cell in which first target information indicated by the BFR MAC CE is located.

The cell in which the first target information indicated by the BFR MAC CE is located may be a cell with a beam failure indicated by the BFR MAC CE.

A manner of determining the preset time based on the minimum value of the subcarrier spacing of the active BWP in which the BFRR is located and the subcarrier spacing of the active BWP in the cell in which the first target information indicated by the BFR MAC CE is located may be defined by the protocol or pre-configured by the network side. For example, the subcarrier spacing of the activated BWP in which the BFRR is located is 15 kHz, and the subcarrier spacing of the active BWP in the cell in which the first target information indicated by the BFR MAC CE is 120 kHz; in this case, the preset time may be determined based on the minimum value 15 kHz of the two subcarrier spacings.

Because a symbol length corresponding to different subcarrier spacings is different, a smaller subcarrier spacing indicates a longer corresponding symbol length. The duration of the preset time, namely a total time of the number of symbols required for the preset time, is determined based on the minimum subcarrier spacing. This can ensure that the preset time is long enough, so that the terminal can correctly complete beam resetting or updating of the target channel in a timely manner.

In this embodiment of the application, the terminal performs measurement based on a plurality of BFD RS sets, where the plurality of BFD RS sets respectively correspond to a plurality of pieces of target information, and at least one of control channels corresponding to the target information uses a unified TCI state; and sends a BFRQ in a case that a measurement result of at least one BFD RS set meets a preset condition. This can support BFR initiation based on a unified TCI framework in a scenario with a plurality of BFD RS sets, thus improving transmission reliability of the terminal.

Referring to FIG. 3, FIG. 3 is a structural diagram of a beam failure detection apparatus according to an embodiment of this application. As shown in FIG. 3, the apparatus includes:
a measurement module 301, configured to perform measurement based on a plurality of beam failure detection reference signal BFD RS sets, where the plurality of BFD RS sets respectively correspond to a plurality of pieces of target information, and at least one of control channels corresponding to the target information uses a unified transmission configuration indicator TCI state; and
a sending module 302, configured to send a beam failure recovery request BFRQ in a case that a measurement result of at least one BFD RS set meets a preset condition.

Optionally, the target information includes at least one of the following:
a control resource set CORESET pool index, a transmission and reception point TRP identifier, a channel group identifier, a CORESET group identifier, a physical uplink control channel PUCCH resource group identifier, a unified TCI state indicated by a network, a codepoint corresponding to the unified TCI state indicated by the network, and a physical cell identifier PCI.

Optionally, in a case that the plurality of BFD RS sets are explicitly configured on a network side, the apparatus further includes:
an updating module, configured to update a TCI state of each BFD RS in the plurality of BFD RS sets based on at least one of the following:
radio resource control RRC signaling;
a media access control control element MAC CE; and
a unified TCI state indicated by a network, where the unified TCI state indicated by the network corresponds to same target information as a BFD RS set to which the BFD RS belongs, or the unified TCI state indicated by the network has a correspondence with the BFD RS set to which the BFD RS belongs.

Optionally, in a case that the plurality of BFD RS sets are explicitly configured on a network side:
a BFD RS resource of the i-th BFD RS set in the plurality of BFD RS sets is the same as or quasi-co-located QCLed with a source RS of a unified TCI state corresponding to the i-th target information corresponding to the i-th BFD RS set; or
the BFD RS resource of the i-th BFD RS set in the plurality of BFD RS sets is QCLed with a physical downlink control channel PDCCH on a target CORESET of the i-th target information; where
i is a positive number greater than or equal to 1 and less than N, and N is the number of BFD RS sets of the plurality of BFD RS sets.

Optionally, in a case that the plurality of BFD RS sets are implicitly configured on a network side:
a source RS of a first TCI state is used as a BFD RS of a first BFD RS set in the plurality of BFD RS sets, where the first TCI state includes a unified TCI state used by a CORESET associated with target information corresponding to the first BFD RS set; or
a source RS of a second TCI state is used as a BFD RS of a second BFD RS set in the plurality of BFD RS sets, where the second TCI state includes a TCI state corresponding to the same target information as the second BFD RS set; or
a source RS of a third TCI state is used as a BFD RS of a third BFD RS set in the plurality of BFD RS sets, where the third TCI state includes a TCI state corresponding to third BFD RS set; or
a source RS of a fourth TCI state is used as a BFD RS in the plurality of BFD RS sets, where the fourth TCI state includes: a TCI state of a CORESET associated with the terminal or a TCI state of a CORESET associated with the terminal and using a unified TCI state indicated by a network.

Optionally, a plurality of new beam identification reference signal NBI-RS sets are configured for the terminal, and the plurality of NBI-RS sets are in one-to-one correspondence to the plurality of BFD RS sets.

Optionally, a BFD RS set and a NBI-RS set having a correspondence are associated with same target information.

Optionally, at least two NBI-RS of a first NBI-RS set in the plurality of NBI-RS sets are associated with different target information.

Optionally, the sending a BFRQ includes at least one of the following:
sending a beam failure recovery BFR media access control control element MAC CE by using an available uplink grant;
sending a physical uplink control channel scheduling request PUCCH-SR; and
performing contention-based random access CBRA.

Optionally, in a case that a unified TCI state used by at least one of control channels corresponding to first target information is a joint TCI state, and radio link measurement results, detected by the terminal, of all BFD RS resources in the BFD RS set corresponding to the first target information are lower than a first preset threshold, the sending a BFR MAC CE by using an available uplink grant includes at least one of the following:
sending the BFR MAC CE by using a latest available uplink grant of the first target information;
sending the BFR MAC CE by using a latest available uplink grant of second target information in the plurality of pieces of target information, where a measurement result not lower than the first preset threshold is present in radio link measurement results, detected by the terminal, of all BFD RS resources in a BFD RS set corresponding to the second target information; and
sending the BFR MAC CE by using M latest available uplink grants of M pieces of target information in the plurality of pieces of target information, where the M pieces of target information are target information with a latest available uplink grant in the plurality of pieces of target information, and M is an integer greater than or equal to 1.

Optionally, the sending the BFR MAC CE by using a latest available uplink grant of the first target information includes:
in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received, sending the BFR MAC CE by using the latest available uplink grant of the first target information; and/or
the sending the BFR MAC CE by using a latest available uplink grant of second target information in the plurality of pieces of target information includes:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received, sending the BFR MAC CE by using the latest available uplink grant of the second target information.

Optionally, in a case that a unified TCI state used by at least one of control channels corresponding to first target information is a joint TCI state, the sending a PUCCH-SR includes at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
sending the PUCCH-SR in a case that the terminal does not have a latest available uplink grant of second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received; and
sending the PUCCH-SR in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, where the M pieces of target information are target information with a latest available uplink grant in the plurality of pieces of target information, and M is an integer greater than or equal to 1.

Optionally, the sending a PUCCH-SR includes at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a first BFD RS set corresponding to the first target information; and
in a case that a plurality of PUCCH-SR resources are configured for the terminal, sending the PUCCH-SR by using a PUCCH-SR resource corresponding to the second target information in the plurality of pieces of target information, or sending the PUCCH-SR by using a PUCCH-SR resource corresponding to a second BFD RS set corresponding to the second target information in the plurality of pieces of target information.

Optionally, the PUCCH-SR resource is located in a primary cell Pcell; or
the PUCCH-SR resource is associated with a neighboring cell PCI; or
the PUCCH-SR resource is located in a cell in which no beam failure occurs.

Optionally, a TCI state of the PUCCH-SR is determined based on a joint TCI state or an uplink TCI state of the second target information in the plurality of pieces of target information, where a measurement result not lower than a first preset threshold is present in radio link measurement results, detected by the terminal, of all BFD RS resources in a second BFD RS set corresponding to the second target information; or
a TCI state of the PUCCH-SR is determined based on a TCI state of target information associated with a PUCCH-SR resource; or
a TCI state of the PUCCH-SR is determined based on a TCI state of a BFD-RS set associated with a PUCCH-SR resource; or
the terminal performs repetition transmission of the PUCCH-SR based on a TCI state of the plurality of pieces of target information; or
the terminal performs repetition transmission of the PUCCH-SR based on a TCI state of the plurality of BFD RS sets.

Optionally, in a case that a unified TCI state used by at least one of control channels corresponding to first target information is a joint TCI state, the performing CBRA includes at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received;
performing CBRA in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, where the M pieces of target information are target information with a latest available uplink grant in the plurality of pieces of target information, and M is an integer greater than or equal to 1;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in a BFD RS set corresponding to a PUCCH-SR resource used for sending the PUCCH-SR are lower than a first preset threshold; and
performing CBRA in a case that radio link measurement results, detected by the terminal, of all BFD RS resources in the plurality of BFD RS sets are lower than the first preset threshold.

Optionally, in a case that a unified TCI state used by at least one of control channels corresponding to first target information is a separate TCI state, and radio link measurement results, detected by the terminal, of all BFD RS resources in the BFD RS set corresponding to the first target information are lower than a first preset threshold, the sending a BFR MAC CE by using an available uplink grant includes at least one of the following:
sending the BFR MAC CE by using a latest available uplink grant of the first target information; and
sending the BFR MAC CE by using a latest available uplink grant of third target information in the plurality of pieces of target information.

Optionally, the sending the BFR MAC CE by using a latest available uplink grant of third target information in the plurality of pieces of target information includes:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information and beam failure recovery response information of the network side is not received, sending the BFR MAC CE by using the latest available uplink grant of the third target information.

Optionally, in a case that a unified TCI state used by at least one of control channels corresponding to first target information is a separate TCI state, the sending a PUCCH-SR includes at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received; and
sending the PUCCH-SR in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received.

Optionally, the sending a PUCCH-SR includes at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a BFD RS set corresponding to the first target information; and
in a case that a plurality of PUCCH-SR resources are configured for the terminal, sending the PUCCH-SR by using a PUCCH-SR resource corresponding to the third target information in the plurality of pieces of target information, or sending the PUCCH-SR by using a PUCCH-SR resource corresponding to a BFD RS set corresponding to the third target information in the plurality of pieces of target information.

Optionally, the PUCCH-SR resource is located in a primary cell Pcell; or
the PUCCH-SR resource is associated with a neighboring cell PCI; or
the PUCCH-SR resource is located in a cell in which no beam failure occurs.

Optionally, a TCI state of the PUCCH-SR is determined based on an uplink TCI state of the first target information; or
a TCI state of the PUCCH-SR is determined based on a joint TCI state or an uplink TCI state of the third target information in the plurality of pieces of target information; or
a TCI state of the PUCCH-SR is determined based on a TCI state of target information associated with a PUCCH-SR resource; or
a TCI state of the PUCCH-SR is determined based on a TCI state of a BFD-RS set associated with a PUCCH-SR resource; or
the terminal performs repetition transmission of the PUCCH-SR based on a TCI state of the plurality of pieces of target information; or
the terminal performs repetition transmission of the PUCCH-SR based on a TCI state of the plurality of BFD RS sets.

Optionally, in a case that a unified TCI state used by at least one of control channels corresponding to first target information is a separate TCI state, the performing CBRA includes at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in a BFD RS set corresponding to a PUCCH-SR resource used for sending the PUCCH-SR are lower than a first preset threshold; and
performing CBRA in a case that radio link measurement results, detected by the terminal, of all BFD RS resources in the plurality of BFD RS sets are lower than the first preset threshold.

Optionally, in a case that a unified TCI state used by at least one of control channels corresponding to first target information is a separate TCI state, the performing CBRA includes at least one of the following:
performing, by the terminal, repetition transmission of a random access channel RACH based on a TCI state of the plurality of pieces of target information; or
performing, by the terminal, repetition transmission of a RACH based on a TCI state of the plurality of BFD RS sets.

Optionally, the apparatus further includes:
an execution module, configured to: in a case that radio link measurement results of all BFD RS resources in a BFD-RS set associated with a PCI of a serving cell are lower than a first preset threshold, and that no new beam is detected based on an NBI-RS set corresponding to the BFD-RS set, perform one of the following:
performing a cell handover;
performing a random access procedure; and
performing a radio link failure and reestablishment procedure.

Optionally, the apparatus further includes:
a receiving module, configured to receive a BFRR, where the BFRR includes at least one of the following:
first DCI that carries a toggled new data identifier NDI and schedules a PUSCH by using a same hybrid automatic repeat request HARQ process identifier ID as a physical uplink shared channel PUSCH in which a BFR MAC CE is located, where the BFR MAC CE is a BFR MAC CE sent by the terminal; and
second DCI for indicating a unified TCI state.

Optionally, the second DCI includes the first DCI, or the second DCI is different from the first DCI; and/or
the unified TCI state indicated by the second DCI is a TCI state determined based on a new beam indicated in the BFR MAC CE.

Optionally, a TCI state of the BFRR is determined based on a new beam indicated in the BFR MAC CE; or
a TCI state of the BFRR is determined based on a TCI state of fourth target information in the plurality of pieces of target information, where a measurement result not lower than a first preset threshold is present in radio link measurement results, detected by the terminal, of all BFD RS resources in a BFD RS set corresponding to the fourth target information.

Optionally, the apparatus further includes:
a determining module, configured to: determine a TCI state of a target channel based on a target parameter starting from a preset time after reception of the BFRR; where
the target channel includes at least one of the following:
a downlink channel associated with first target information;
a downlink channel associated with a first BFD RS set corresponding to the first target information;
a downlink channel using a unified TCI state indicated by a network;
an uplink channel associated with the first target information;
an uplink channel associated with the first BFD RS set; and
an uplink channel using a unified TCI state indicated by the network;
radio link measurement results, detected by the terminal, of all BFD RS resources in a BFD RS set corresponding to the first target information are lower than a first preset threshold; and
the target event includes at least one of the following:
new beam information indicated by the BFR MAC CE;
a TCI state indicated by the BFRR; and
beam information of a latest transmitted physical random access channel PRACH.

Optionally, the preset time includes at least one of the following:
X symbols after reception of the BFRR, where X is a positive integer;
a beam application time of a unified TCI state indicated by the BFRR; and
a minimum value or maximum value of X symbols after reception of the BFRR and the beam application time of the unified TCI state indicated by the BFRR.

Optionally, the preset time is determined based on a minimum value of a subcarrier spacing of an active BWP in which the BFRR is located and a subcarrier spacing of an active BWP in a cell in which first target information indicated by the BFR MAC CE is located.

The beam failure detection apparatus can improve transmission reliability of the terminal.

The beam failure detection apparatus in this embodiment of this application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal listed in the embodiment of this application, and other devices may be a server, a network attached storage (NAS), and the like. This is not limited in the embodiment of this application.

The beam failure detection apparatus provided in this embodiment of this application is capable of implementing the processes implemented in the method embodiments shown in FIG. 2, with the same technical effects achieved. To avoid repetition, details are not described herein again.

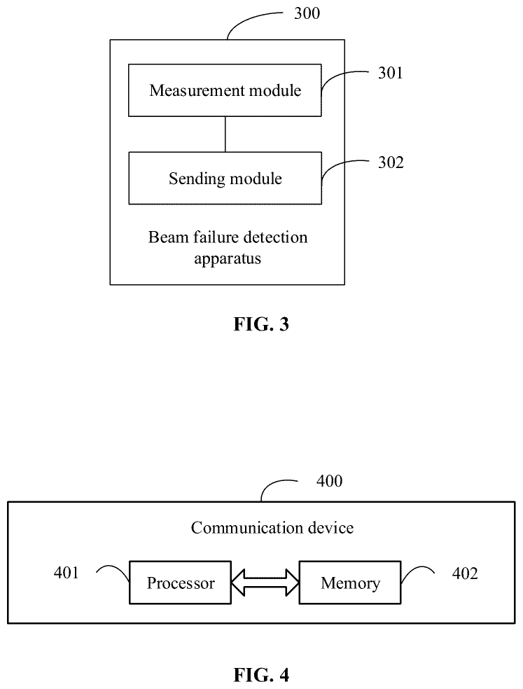

Optionally, as shown in FIG. 4, an embodiment of this application further provides a communication device 400, including a processor 401, a memory 402, and a program or instructions stored in the memory 402 and capable of running on the processor 401. For example, when the communication device 400 is a terminal and when the program or the instructions are executed by the processor 401, the steps of the foregoing embodiments of the beam failure detection method on the terminal side are implemented, with the same technical effects achieved. When the communications device 400 is a network-side device and when the program or the instructions are executed by the processor 401, the processes of the foregoing embodiments of the beam failure detection method on the network-side device side are implemented, with the same technical effects achieved. To avoid repetition, details are not described herein again.

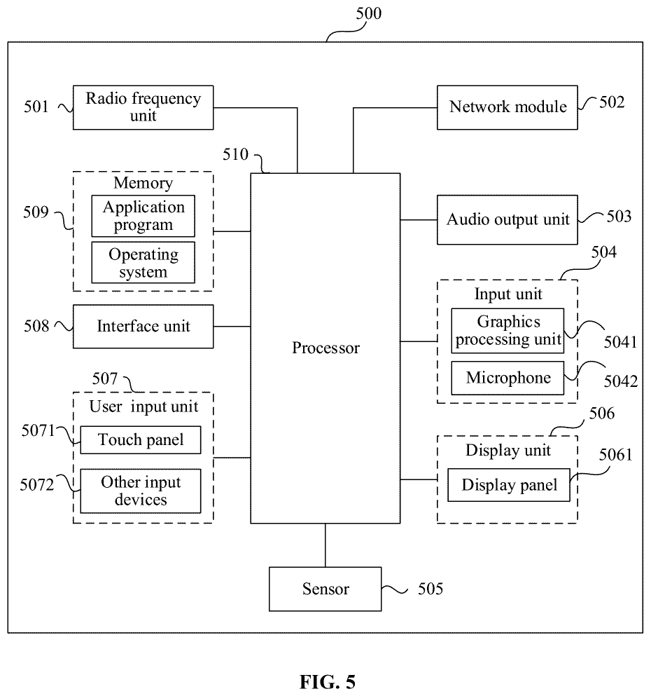

An embodiment of this application further provides a terminal, including a processor and a communication interface, where at least one of the processor and the communication interface is configured to perform measurement based on a plurality of beam failure detection reference signal BFD RS sets, where the plurality of BFD RS sets respectively correspond to a plurality of pieces of target information, and at least one of control channels corresponding to the target information uses a unified transmission configuration indicator TCI state; and a sending module, configured to send a beam failure recovery request BFRQ in a case that a measurement result of at least one BFD RS set meets a preset condition. The terminal embodiments correspond to the foregoing terminal-side method embodiments, and the implementation processes and implementations of the foregoing method embodiments can be applied to the terminal embodiments, with the same technical effects achieved. Specifically, FIG. 5 is a schematic diagram of a hardware structure of a terminal for implementing the embodiments of this application.

The terminal 500 includes but is not limited to at least part of components such as a radio frequency unit 501, a network module 502, an audio output unit 503, an input unit 504, a sensor 505, a display unit 506, a user input unit 507, an interface unit 508, a memory 509, and a processor 510.

Persons skilled in the art can understand that the terminal 500 may further include a power supply (for example, a battery) supplying power to the components, and the power supply may be logically connected to the processor 510 through a power management system. In this way, functions such as charge management, discharge management, and power consumption management are implemented by using the power management system. The structure of the terminal shown in FIG. 5 does not constitute any limitation on the terminal. The terminal may include more or fewer components than shown in the figure, or a combination of some components, or the components disposed differently. Details are not described herein again.

It can be understood that in this embodiment of this application, the input unit 504 may include a graphics processing unit (GPU) 5041 and a microphone 5042. The graphics processing unit 5041 processes image data of a still picture or video obtained by an image capture apparatus (such as a camera) in a video capture mode or an image capture mode. The display unit 506 may include a display panel 5061, and the display panel 5061 may be configured in a form of a liquid crystal display, an organic light-emitting diode, and the like. The user input unit 507 may include at least one of a touch panel 5071 and other input devices 5072. The touch panel 5071 is also referred to as a touchscreen. The touch panel 5071 may include two parts: a touch detection apparatus and a touch controller. The other input devices 5072 may include but are not limited to a physical keyboard, a function key (such as a volume control key or a power on/off key), a trackball, a mouse, a joystick, and the like. Details are not described herein.

In this embodiment of this application, the radio frequency unit 501 receives downlink data from a network-side device, and then sends the downlink data to the processor 510 for processing. In addition, the radio frequency unit 501 may send uplink data to the network-side device. Generally, the radio frequency unit 501 includes but is not limited to an antenna, an amplifier, a transceiver, a coupler, a low noise amplifier, a duplexer, and the like.

The memory 509 may be configured to store software programs or instructions and various data. The memory 509 may include a first storage area for storing a program or instructions and a second storage area for storing data. The first storage area may store an operating system, an application program or instruction required by at least one function (for example, a sound playback function or an image playback function), and the like. In addition, the memory 509 may include a volatile memory or a non-volatile memory, or the memory 509 may include both a volatile memory and a non-volatile memory. The non-volatile memory may be a read-only memory (ROM), a programmable read only memory (Programmable ROM, PROM), an erasable programmable read-only memory (Erasable PROM, EPROM), and an electrically erasable programmable read-only memory (Electrically EPROM, EEPROM), or flash memory. The volatile memory can be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 509 in the embodiments of this application includes but is not limited to these and any other suitable types of memories.

The processor 510 may include one or more processing units. Optionally, an application processor and a modem processor may be integrated in the processor 510. The application processor primarily processes operations involving an operating system, user interfaces, application programs, and the like. The modem processor primarily processes radio communication signals, for example, being a baseband processor. It can be understood that the modem processor may alternatively be not integrated in the processor 510.

The processor 510 or the radio frequency unit 501 is configured to perform measurement based on a plurality of beam failure detection reference signal BFD RS sets, where the plurality of BFD RS sets respectively correspond to a plurality of pieces of target information, and at least one of control channels corresponding to the target information uses a unified transmission configuration indicator TCI state; and
the radio frequency unit 501 is configured to send a beam failure recovery request BFRQ in a case that a measurement result of at least one BFD RS set meets a preset condition.

Optionally, the target information includes at least one of the following:
a control resource set CORESET pool index, a transmission and reception point TRP identifier, a channel group identifier, a CORESET group identifier, a physical uplink control channel PUCCH resource group identifier, a unified TCI state indicated by a network, a codepoint corresponding to the unified TCI state indicated by the network, and a physical cell identifier PCI.

Optionally, in a case that the plurality of BFD RS sets are explicitly configured on a network side, the processor 510 is further configured to:
update a TCI state of each BFD RS in the plurality of BFD RS sets based on at least one of the following:
radio resource control RRC signaling;
a media access control control element MAC CE; and
a unified TCI state indicated by a network, where the unified TCI state indicated by the network corresponds to same target information as a BFD RS set to which the BFD RS belongs, or the unified TCI state indicated by the network has a correspondence with the BFD RS set to which the BFD RS belongs.

Optionally, in a case that the plurality of BFD RS sets are explicitly configured on a network side:
a BFD RS resource of the i-th BFD RS set in the plurality of BFD RS sets is the same as or quasi-co-located QCLed with a source RS of a unified TCI state corresponding to the i-th target information corresponding to the i-th BFD RS set; or
the BFD RS resource of the i-th BFD RS set in the plurality of BFD RS sets is QCLed with a physical downlink control channel PDCCH on a target CORESET of the i-th target information; where
i is a positive number greater than or equal to 1 and less than N, and N is the number of BFD RS sets of the plurality of BFD RS sets.

Optionally, in a case that the plurality of BFD RS sets are implicitly configured on a network side:
a source RS of a first TCI state is used as a BFD RS of a first BFD RS set in the plurality of BFD RS sets, where the first TCI state includes a unified TCI state used by a CORESET associated with target information corresponding to the first BFD RS set; or
a source RS of a second TCI state is used as a BFD RS of a second BFD RS set in the plurality of BFD RS sets, where the second TCI state includes a TCI state corresponding to the same target information as the second BFD RS set; or
a source RS of a third TCI state is used as a BFD RS of a third BFD RS set in the plurality of BFD RS sets, where the third TCI state includes a TCI state corresponding to third BFD RS set; or
a source RS of a fourth TCI state is used as a BFD RS in the plurality of BFD RS sets, where the fourth TCI state includes: a TCI state of a CORESET associated with the terminal or a TCI state of a CORESET associated with the terminal and using a unified TCI state indicated by a network.

Optionally, a plurality of new beam identification reference signal NBI-RS sets are configured for the terminal, and the plurality of NBI-RS sets are in one-to-one correspondence to the plurality of BFD RS sets.

Optionally, a BFD RS set and a NBI-RS set having a correspondence are associated with same target information.

Optionally, at least two NBI-RS of a first NBI-RS set in the plurality of NBI-RS sets are associated with different target information.

Optionally, the sending a BFRQ includes at least one of the following:
sending a beam failure recovery BFR media access control control element MAC CE by using an available uplink grant;
sending a physical uplink control channel scheduling request PUCCH-SR; and
performing contention-based random access CBRA.

Optionally, in a case that a unified TCI state used by at least one of control channels corresponding to first target information is a joint TCI state, and radio link measurement results, detected by the terminal, of all BFD RS resources in the BFD RS set corresponding to the first target information are lower than a first preset threshold, the sending a BFR MAC CE by using an available uplink grant includes at least one of the following:
sending the BFR MAC CE by using a latest available uplink grant of the first target information;
sending the BFR MAC CE by using a latest available uplink grant of second target information in the plurality of pieces of target information, where a measurement result not lower than the first preset threshold is present in radio link measurement results, detected by the terminal, of all BFD RS resources in a BFD RS set corresponding to the second target information; and
sending the BFR MAC CE by using M latest available uplink grants of M pieces of target information in the plurality of pieces of target information, where the M pieces of target information are target information with a latest available uplink grant in the plurality of pieces of target information, and M is an integer greater than or equal to 1.

Optionally, the sending the BFR MAC CE by using a latest available uplink grant of the first target information includes:
in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received, sending the BFR MAC CE by using the latest available uplink grant of the first target information; and/or
the sending the BFR MAC CE by using a latest available uplink grant of second target information in the plurality of pieces of target information includes:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received, sending the BFR MAC CE by using the latest available uplink grant of the second target information.

Optionally, in a case that a unified TCI state used by at least one of control channels corresponding to first target information is a joint TCI state, the sending a PUCCH-SR includes at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
sending the PUCCH-SR in a case that the terminal does not have a latest available uplink grant of second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received; and
sending the PUCCH-SR in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, where the M pieces of target information are target information with a latest available uplink grant in the plurality of pieces of target information, and M is an integer greater than or equal to 1.

Optionally, the sending a PUCCH-SR includes at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a first BFD RS set corresponding to the first target information; and
in a case that a plurality of PUCCH-SR resources are configured for the terminal, sending the PUCCH-SR by using a PUCCH-SR resource corresponding to the second target information in the plurality of pieces of target information, or sending the PUCCH-SR by using a PUCCH-SR resource corresponding to a second BFD RS set corresponding to the second target information in the plurality of pieces of target information.

Optionally, the PUCCH-SR resource is located in a primary cell Pcell; or
the PUCCH-SR resource is associated with a neighboring cell PCI; or
the PUCCH-SR resource is located in a cell in which no beam failure occurs.

Optionally, a TCI state of the PUCCH-SR is determined based on a joint TCI state or an uplink TCI state of the second target information in the plurality of pieces of target information, where a measurement result not lower than a first preset threshold is present in radio link measurement results, detected by the terminal, of all BFD RS resources in a second BFD RS set corresponding to the second target information; or
a TCI state of the PUCCH-SR is determined based on a TCI state of target information associated with a PUCCH-SR resource; or
a TCI state of the PUCCH-SR is determined based on a TCI state of a BFD-RS set associated with a PUCCH-SR resource; or
the terminal performs repetition transmission of the PUCCH-SR based on a TCI state of the plurality of pieces of target information; or
the terminal performs repetition transmission of the PUCCH-SR based on a TCI state of the plurality of BFD RS sets.

Optionally, in a case that a unified TCI state used by at least one of control channels corresponding to first target information is a joint TCI state, the performing CBRA includes at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received;
performing CBRA in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, where the M pieces of target information are target information with a latest available uplink grant in the plurality of pieces of target information, and M is an integer greater than or equal to 1;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in lower than a first preset threshold; and
performing CBRA in a case that radio link measurement results, detected by the terminal, of all BFD RS resources in the plurality of BFD RS sets are lower than the first preset threshold.

Optionally, in a case that a unified TCI state used by at least one of control channels corresponding to first target information is a separate TCI state, and radio link measurement results, detected by the terminal, of all BFD RS resources in the BFD RS set corresponding to the first target information are lower than a first preset threshold, the sending a BFR MAC CE by using an available uplink grant includes at least one of the following:
sending the BFR MAC CE by using a latest available uplink grant of the first target information; and
sending the BFR MAC CE by using a latest available uplink grant of third target information in the plurality of pieces of target information.

Optionally, the sending the BFR MAC CE by using a latest available uplink grant of third target information in the plurality of pieces of target information includes:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information and beam failure recovery response information of the network side is not received, sending the BFR MAC CE by using the latest available uplink grant of the third target information.

Optionally, in a case that a unified TCI state used by at least one of control channels corresponding to first target information is a separate TCI state, the sending a PUCCH-SR includes at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received; and
sending the PUCCH-SR in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received.

Optionally, the sending a PUCCH-SR includes at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a BFD RS set corresponding to the first target information; and
in a case that a plurality of PUCCH-SR resources are configured for the terminal, sending the PUCCH-SR by using a PUCCH-SR resource corresponding to the third target information in the plurality of pieces of target information, or sending the PUCCH-SR by using a PUCCH-SR resource corresponding to a BFD RS set corresponding to the third target information in the plurality of pieces of target information.

Optionally, the PUCCH-SR resource is located in a primary cell Pcell; or
the PUCCH-SR resource is associated with a neighboring cell PCI; or
the PUCCH-SR resource is located in a cell in which no beam failure occurs.

Optionally, a TCI state of the PUCCH-SR is determined based on an uplink TCI state of the first target information; or
a TCI state of the PUCCH-SR is determined based on a joint TCI state or an uplink TCI state of the third target information in the plurality of pieces of target information; or
a TCI state of the PUCCH-SR is determined based on a TCI state of target information associated with a PUCCH-SR resource; or
a TCI state of the PUCCH-SR is determined based on a TCI state of a BFD-RS set associated with a PUCCH-SR resource; or
the terminal performs repetition transmission of the PUCCH-SR based on a TCI state of the plurality of pieces of target information; or
the terminal performs repetition transmission of the PUCCH-SR based on a TCI state of the plurality of BFD RS sets.

Optionally, in a case that a unified TCI state used by at least one of control channels corresponding to first target information is a separate TCI state, the performing CBRA includes at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in lower than a first preset threshold; and
performing CBRA in a case that radio link measurement results, detected by the terminal, of all BFD RS resources in the plurality of BFD RS sets are lower than the first preset threshold.

Optionally, in a case that a unified TCI state used by at least one of control channels corresponding to first target information is a separate TCI state, the performing CBRA includes at least one of the following:
performing, by the terminal, repetition transmission of a random access channel RACH based on a TCI state of the plurality of pieces of target information; or
performing, by the terminal, repetition transmission of a RACH based on a TCI state of the plurality of BFD RS sets.

Optionally, after the BFRQ is sent, the processor 510 or the radio frequency unit 501 is further configured to:
in a case that radio link measurement results of all BFD RS resources in a BFD-RS set associated with a PCI of a serving cell are lower than a first preset threshold, and that no new beam is detected based on an NBI-RS set corresponding to the BFD-RS set, perform one of the following:
performing a cell handover;
performing a random access procedure; and
performing a radio link failure and reestablishment procedure.

Optionally, the radio frequency unit 501 is further configured to:
receive a beam failure recovery response BFRR, where the BFRR includes at least one of the following:
first DCI that carries a toggled new data identifier NDI and schedules a PUSCH by using a same hybrid automatic repeat request HARQ process identifier ID as a physical uplink shared channel PUSCH in which a BFR MAC CE is located, where the BFR MAC CE is a BFR MAC CE sent by the terminal; and
second DCI for indicating a unified TCI state.

Optionally, the second DCI includes the first DCI, or the second DCI is different from the first DCI; and/or
the unified TCI state indicated by the second DCI is a TCI state determined based on a new beam indicated in the BFR MAC CE.

Optionally, a TCI state of the BFRR is determined based on a new beam indicated in the BFR MAC CE; or
a TCI state of the BFRR is determined based on a TCI state of fourth target information in the plurality of pieces of target information, where a measurement result not lower than a first preset threshold is present in radio link measurement results, detected by the terminal, of all BFD RS resources in a BFD RS set corresponding to the fourth target information.

Optionally, the processor 510 is further configured to:
determine a TCI state of a target channel based on a target parameter starting from a preset time after reception of the BFRR; where
the target channel includes at least one of the following:
a downlink channel associated with first target information;
a downlink channel associated with a first BFD RS set corresponding to the first target information;
a downlink channel using a unified TCI state indicated by a network;
an uplink channel associated with the first target information;
an uplink channel associated with the first BFD RS set; and
an uplink channel using a unified TCI state indicated by the network;
radio link measurement results, detected by the terminal, of all BFD RS resources in a BFD RS set corresponding to the first target information are lower than a first preset threshold; and
the target event includes at least one of the following:
new beam information indicated by the BFR MAC CE;
a TCI state indicated by the BFRR; and
beam information of a latest transmitted physical random access channel PRACH.

Optionally, the preset time includes at least one of the following:
X symbols after reception of the BFRR, where X is a positive integer;
a beam application time of a unified TCI state indicated by the BFRR; and
a minimum value or maximum value of X symbols after reception of the BFRR and the beam application time of the unified TCI state indicated by the BFRR.

Optionally, the preset time is determined based on a minimum value of a subcarrier spacing of an active BWP in which the BFRR is located and a subcarrier spacing of an active BWP in a cell in which first target information indicated by the BFR MAC CE is located.

The terminal can improve transmission reliability of the terminal.

An embodiment of this application further provides a readable storage medium, where a program or instructions are stored in the readable storage medium. When the program or the instructions are executed by a processor, the processes of the foregoing embodiment of the beam failure detection method described above can be implemented, with the same technical effects achieved. To avoid repetition, details are not described herein again.

The processor is a processor in the terminal described in the foregoing embodiments. The readable storage medium includes a computer-readable storage medium, for example, a computer read only memory ROM, a random access memory RAM, a magnetic disk, or an optical disc.

An embodiment of this application further provides a chip, where the chip includes a processor and a communication interface. The communication interface is coupled to the processor, and the processor is configured to run a program or instructions to implement the processes of the foregoing beam failure detection method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the foregoing beam failure detection method embodiments, with the same technical effects achieved. To avoid repetition, details are not repeated herein.

An embodiment of this application further provides a beam failure detection system, which includes a terminal and a network-side device, where the terminal can be configured to execute the steps of the beam failure detection method.

It should be noted that in this specification, the term “include”, “comprise”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described method may be performed in an order different from the order described, and steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Certainly, the method in the foregoing embodiments may alternatively be implemented by hardware. However, in many cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A beam failure detection method, comprising:
performing, by a terminal, measurement based on a plurality of beam failure detection reference signal BFD RS sets, wherein the plurality of BFD RS sets respectively correspond to a plurality of pieces of target information, and at least one of control channels corresponding to the target information uses a unified transmission configuration indicator TCI state; and
sending a beam failure recovery request BFRQ in a case that a measurement result of at least one BFD RS set meets a preset condition.

2. The method according to claim 1, wherein the target information comprises at least one of the following:
a control resource set CORESET pool index, a transmission and reception point TRP identifier, a channel group identifier, a CORESET group identifier, a physical uplink control channel PUCCH resource group identifier, a unified TCI state indicated by a network, a codepoint corresponding to the unified TCI state indicated by the network, and a physical cell identifier PCI.

3. The method according to claim 1, wherein in a case that the plurality of BFD RS sets are explicitly configured on a network side, the method further comprises:
updating, by the terminal, a TCI state of each BFD RS in the plurality of BFD RS sets based on at least one of the following:
radio resource control RRC signaling;
a media access control control element MAC CE; and
a unified TCI state indicated by a network, wherein the unified TCI state indicated by the network corresponds to same target information as a BFD RS set to which the BFD RS belongs, or the unified TCI state indicated by the network has a correspondence with the BFD RS set to which the BFD RS belongs;
or,
wherein in a case that the plurality of BFD RS sets are explicitly configured on a network side:
a BFD RS resource of the i-th BFD RS set in the plurality of BFD RS sets is the same as or quasi-co-located QCLed with a source RS of a unified TCI state corresponding to the i-th target information corresponding to the i-th BFD RS set; or
the BFD RS resource of the i-th BFD RS set in the plurality of BFD RS sets is QCLed with a physical downlink control channel PDCCH on a target CORESET of the i-th target information; wherein
i is a positive number greater than or equal to 1 and less than N, and N is the number of BFD RS sets of the plurality of BFD RS sets;
or,
wherein in a case that the plurality of BFD RS sets are implicitly configured on a network side:
a source RS of a first TCI state is used as a BFD RS of a first BFD RS set in the plurality of BFD RS sets, wherein the first TCI state comprises a unified TCI state used by a CORESET associated with target information corresponding to the first BFD RS set; or
a source RS of a second TCI state is used as a BFD RS of a second BFD RS set in the plurality of BFD RS sets, wherein the second TCI state comprises a TCI state corresponding to the same target information as the second BFD RS set; or
a source RS of a third TCI state is used as a BFD RS of a third BFD RS set in the plurality of BFD RS sets, wherein the third TCI state comprises a TCI state corresponding to third BFD RS set; or
a source RS of a fourth TCI state is used as a BFD RS in the plurality of BFD RS sets, wherein the fourth TCI state comprises: a TCI state of a CORESET associated with the terminal or a TCI state of a CORESET associated with the terminal and using a unified TCI state indicated by a network.

4. The method according to claim 1, wherein a plurality of new beam identification reference signal NBI-RS sets are configured for the terminal, and the plurality of NBI-RS sets are in one-to-one correspondence to the plurality of BFD RS sets;
wherein a BFD RS set and a NBI-RS set having a correspondence are associated with same target information;
wherein at least two NBI-RS of a first NBI-RS set in the plurality of NBI-RS sets are associated with different target information.

5. The method according to claim 1 wherein the sending a BFRQ comprises at least one of the following:
sending a beam failure recovery BFR media access control control element MAC CE by using an available uplink grant;
sending a physical uplink control channel scheduling request PUCCH-SR; and
performing contention-based random access CBRA.

6. The method according to claim 5, wherein in a case that a unified TCI state used by at least one of control channels corresponding to first target information is a joint TCI state, and radio link measurement results, detected by the terminal, of all BFD RS resources in the BFD RS set corresponding to the first target information are lower than a first preset threshold, the sending a BFR MAC CE by using an available uplink grant comprises at least one of the following:
sending the BFR MAC CE by using a latest available uplink grant of the first target information;
sending the BFR MAC CE by using a latest available uplink grant of second target information in the plurality of pieces of target information, wherein a measurement result not lower than the first preset threshold is present in radio link measurement results, detected by the terminal, of all BFD RS resources in a BFD RS set corresponding to the second target information; and
sending the BFR MAC CE by using M latest available uplink grants of M pieces of target information in the plurality of pieces of target information, wherein the M pieces of target information are target information with a latest available uplink grant in the plurality of pieces of target information, and M is an integer greater than or equal to 1;
or,
wherein in a case that a unified TCI state used by at least one of control channels corresponding to first target information is a separate TCI state, and radio link measurement results, detected by the terminal, of all BFD RS resources in the BFD RS set corresponding to the first target information are lower than a first preset threshold, the sending a BFR MAC CE by using an available uplink grant comprises at least one of the following:
sending the BFR MAC CE by using a latest available uplink grant of the first target information; and
sending the BFR MAC CE by using a latest available uplink grant of third target information in the plurality of pieces of target information.

7. The method according to claim 6, wherein the sending the BFR MAC CE by using a latest available uplink grant of the first target information comprises:
in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received, sending the BFR MAC CE by using the latest available uplink grant of the first target information; and/or
the sending the BFR MAC CE by using a latest available uplink grant of second target information in the plurality of pieces of target information comprises:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received, sending the BFR MAC CE by using the latest available uplink grant of the second target information;
or,
wherein the sending the BFR MAC CE by using a latest available uplink grant of third target information in the plurality of pieces of target information comprises:
in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information and beam failure recovery response information of the network side is not received, sending the BFR MAC CE by using the latest available uplink grant of the third target information.

8. The method according to claim 5, wherein in a case that a unified TCI state used by at least one of control channels corresponding to first target information is a joint TCI state, the sending a PUCCH-SR comprises at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
sending the PUCCH-SR in a case that the terminal does not have a latest available uplink grant of second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received; and
sending the PUCCH-SR in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, wherein the M pieces of target information are target information with a latest available uplink grant in the plurality of pieces of target information, and M is an integer greater than or equal to 1;
or,
wherein in a case that a unified TCI state used by at least one of control channels corresponding to first target information is a joint TCI state, the performing CBRA comprises at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have the latest available uplink grant of the second target information, or that transmission of the BFR MAC CE by using the latest available uplink grant of the second target information is unsuccessful, or that the BFR MAC CE is sent by using the latest available uplink grant of the second target information but beam failure recovery response information of the network side is not received;
performing CBRA in a case that the terminal does not have a latest available uplink grant, or that transmission of the BFR MAC CE by using M latest available uplink grants of M pieces of target information in the plurality of pieces of target information is unsuccessful, or that the BFR MAC CE is transmitted by using M latest available uplink grants of M pieces of target information in the plurality of pieces of target information but beam failure recovery response information of the network side is not received, wherein the M pieces of target information are target information with a latest available uplink grant in the plurality of pieces of target information, and M is an integer greater than or equal to 1;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in a BFD RS set corresponding to a PUCCH-SR resource used for sending the PUCCH-SR are lower than a first preset threshold; and
performing CBRA in a case that radio link measurement results, detected by the terminal, of all BFD RS resources in the plurality of BFD RS sets are lower than the first preset threshold;
or,
wherein in a case that a unified TCI state used by at least one of control channels corresponding to first target information is a separate TCI state, the sending a PUCCH-SR comprises at least one of the following:
sending the PUCCH-SR in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received; and
sending the PUCCH-SR in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received;
or,
wherein in a case that a unified TCI state used by at least one of control channels corresponding to first target information is a separate TCI state, the performing CBRA comprises at least one of the following:
performing CBRA in a case that the terminal does not have the latest available uplink grant of the first target information, or that transmission of the BFR MAC CE by using the latest available uplink grant of the first target information is unsuccessful, or that the BFR MAC CE is sent by using the latest available uplink grant of the first target information but beam failure recovery response information of the network side is not received;
performing CBRA in a case that the terminal does not have a latest available uplink grant of third target information, or that transmission of the BFR MAC CE by using the latest available uplink grant of the third target information is unsuccessful, or that the BFR MAC CE is sent by using the latest available uplink grant of the third target information but beam failure recovery response information of the network side is not received;
performing CBRA in a case that transmission of the PUCCH-SR is unsuccessful and an uplink grant from the network is not received after transmission of the PUCCH-SR, or that a beam failure occurs for the target information corresponding to the PUCCH-SR resource used for sending the PUCCH-SR, or that radio link measurement results of all BFD RS resources in a BFD RS set corresponding to a PUCCH-SR resource used for sending the PUCCH-SR are lower than a first preset threshold; and
performing CBRA in a case that radio link measurement results, detected by the terminal, of all BFD RS resources in the plurality of BFD RS sets are lower than the first preset threshold;
or,
wherein in a case that a unified TCI state used by at least one of control channels corresponding to first target information is a separate TCI state, the performing CBRA comprises at least one of the following:
performing, by the terminal, repetition transmission of a random access channel RACH based on a TCI state of the plurality of pieces of target information; or
performing, by the terminal, repetition transmission of a RACH based on a TCI state of the plurality of BFD RS sets.

9. The method according to claim 8, wherein the sending a PUCCH-SR comprises at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a first BFD RS set corresponding to the first target information; and
in a case that a plurality of PUCCH-SR resources are configured for the terminal, sending the PUCCH-SR by using a PUCCH-SR resource corresponding to the second target information in the plurality of pieces of target information, or sending the PUCCH-SR by using a PUCCH-SR resource corresponding to a second BFD RS set corresponding to the second target information in the plurality of pieces of target information;
or,
wherein the sending a PUCCH-SR comprises at least one of the following:
in a case that one PUCCH-SR resource is configured for the terminal, sending the PUCCH-SR by using the PUCCH-SR resource;
in a case that a plurality of PUCCH-SR resources are configured for the terminal, sending the PUCCH-SR by using a PUCCH-SR resource corresponding to the first target information, or sending the PUCCH-SR by using a PUCCH-SR resource corresponding to a BFD RS set corresponding to the first target information; and
in a case that a plurality of PUCCH-SR resources are configured for the terminal, sending the PUCCH-SR by using a PUCCH-SR resource corresponding to the third target information in the plurality of pieces of target information, or sending the PUCCH-SR by using a PUCCH-SR resource corresponding to a BFD RS set corresponding to the third target information in the plurality of pieces of target information.

10. The method according to claim 1, wherein after the sending a BFRQ, the method further comprises:
in a case that radio link measurement results of all BFD RS resources in a BFD-RS set associated with a PCI of a serving cell are lower than a first preset threshold, and that no new beam is detected based on an NBI-RS set corresponding to the BFD-RS set, performing one of the following:
performing a cell handover;
performing a random access procedure; and
performing a radio link failure and reestablishment procedure.

11. The method according to claim 1, wherein the method further comprises:
receiving, by the terminal, a beam failure recovery response BFRR, wherein the BFRR comprises at least one of the following:
first DCI that carries a toggled new data identifier NDI and schedules a PUSCH by using a same hybrid automatic repeat request HARQ process identifier ID as a physical uplink shared channel PUSCH in which a BFR MAC CE is located, wherein the BFR MAC CE is a BFR MAC CE sent by the terminal; and
second DCI for indicating a unified TCI state.

12. The method according to claim 11, wherein
the second DCI comprises the first DCI, or the second DCI is different from the first DCI; and/or
the unified TCI state indicated by the second DCI is a TCI state determined based on a new beam indicated in the BFR MAC CE.

13. The method according to claim 11, wherein a TCI state of the BFRR is determined based on a new beam indicated in the BFR MAC CE; or
a TCI state of the BFRR is determined based on a TCI state of fourth target information in the plurality of pieces of target information, wherein a measurement result not lower than a first preset threshold is present in radio link measurement results, detected by the terminal, of all BFD RS resources in a BFD RS set corresponding to the fourth target information.

14. The method according to claim 11, wherein the method further comprises:
determining a TCI state of a target channel based on a target parameter starting from a preset time after reception of the BFRR; wherein
the target channel comprises at least one of the following:
a downlink channel associated with first target information;
a downlink channel associated with a first BFD RS set corresponding to the first target information;
a downlink channel using a unified TCI state indicated by a network;
an uplink channel associated with the first target information;
an uplink channel associated with the first BFD RS set; and
an uplink channel using a unified TCI state indicated by the network;
radio link measurement results, detected by the terminal, of all BFD RS resources in a BFD RS set corresponding to the first target information are lower than a first preset threshold; and
the target event comprises at least one of the following:
new beam information indicated by the BFR MAC CE;
a TCI state indicated by the BFRR; and
beam information of a latest transmitted physical random access channel PRACH.

15. The method according to claim 14, wherein the preset time comprises at least one of the following:
X symbols after reception of the BFRR, wherein X is a positive integer;
a beam application time of a unified TCI state indicated by the BFRR; and
a minimum value or maximum value of X symbols after reception of the BFRR and the beam application time of the unified TCI state indicated by the BFRR;
or,
wherein the preset time is determined based on a minimum value of a subcarrier spacing of an active BWP in which the BFRR is located and a subcarrier spacing of an active BWP in a cell in which first target information indicated by the BFR MAC CE is located.

16. A terminal, comprising a processor and a memory, wherein a program or instructions capable of running on the processor are stored in the memory; and the program or the instructions, when executed by the processor, cause the processor to perform:
performing measurement based on a plurality of beam failure detection reference signal BFD RS sets, wherein the plurality of BFD RS sets respectively correspond to a plurality of pieces of target information, and at least one of control channels corresponding to the target information uses a unified transmission configuration indicator TCI state; and
sending a beam failure recovery request BFRQ in a case that a measurement result of at least one BFD RS set meets a preset condition.

17. The terminal according to claim 16, wherein the target information comprises at least one of the following:
a control resource set CORESET pool index, a transmission and reception point TRP identifier, a channel group identifier, a CORESET group identifier, a physical uplink control channel PUCCH resource group identifier, a unified TCI state indicated by a network, a codepoint corresponding to the unified TCI state indicated by the network, and a physical cell identifier PCI.

18. The terminal according to claim 16, wherein the program or the instructions, when executed by the processor, cause the processor to perform:
receiving a beam failure recovery response BFRR, wherein the BFRR comprises at least one of the following:
first DCI that carries a toggled new data identifier NDI and schedules a PUSCH by using a same hybrid automatic repeat request HARQ process identifier ID as a physical uplink shared channel PUSCH in which a BFR MAC CE is located, wherein the BFR MAC CE is a BFR MAC CE sent by the terminal; and
second DCI for indicating a unified TCI state.

19. The terminal according to claim 16, wherein the program or the instructions, when executed by the processor, cause the processor to perform:
determining a TCI state of a target channel based on a target parameter starting from a preset time after reception of the BFRR; wherein
the target channel comprises at least one of the following:
a downlink channel associated with first target information;
a downlink channel associated with a first BFD RS set corresponding to the first target information;
a downlink channel using a unified TCI state indicated by a network;
an uplink channel associated with the first target information;
an uplink channel associated with the first BFD RS set; and
an uplink channel using a unified TCI state indicated by the network;
radio link measurement results, detected by the terminal, of all BFD RS resources in a BFD RS set corresponding to the first target information are lower than a first preset threshold; and
the target event comprises at least one of the following:
new beam information indicated by the BFR MAC CE;
a TCI state indicated by the BFRR; and
beam information of a latest transmitted physical random access channel PRACH.

20. A readable storage medium, wherein the readable storage medium stores a program or instructions; wherein the program or the instructions, when executed by a processor, cause the processor to perform:
performing measurement based on a plurality of beam failure detection reference signal BFD RS sets, wherein the plurality of BFD RS sets respectively correspond to a plurality of pieces of target information, and at least one of control channels corresponding to the target information uses a unified transmission configuration indicator TCI state; and
sending a beam failure recovery request BFRQ in a case that a measurement result of at least one BFD RS set meets a preset condition.
